(19) United States
(12) Patent Application Publication
(10) Pub. No.: US 2020/0023510 A1
(43) Pub. Date: Jan. 23, 2020

(54) SECURING RACK FOR BACKPACK BLOWER

(71) Applicant: Service Industry Solutions, LLC, Riviera Beach, FL (US)

(72) Inventor: David D. Sargent, Riviera Beach, FL (US)

(21) Appl. No.: 16/514,735

(22) Filed: Jul. 17, 2019

Related U.S. Application Data
(60) Provisional application No. 62/699,315, filed on Jul. 17, 2018.

(51) Int. Cl. B25H 3/00; B60R 9/00; B25H 5/00; E05B 73/00

(52) U.S. Cl. CPC B25H 3/006; E05B 73/00; B25H 5/00; B60R 9/00

(57) ABSTRACT

A lockable equipment rack configured to secure equipment, such as a backpack blower, thereto. The locking equipment rack comprises an upper locking assembly and a lower support assembly. The upper locking assembly and the lower support assembly are securable to and movable about a first post and a second post. Attached to the second post is a tube holder assembly configured to receive and hold at least a portion of an air discharge tube or pipe designed to move air. A locking unit provides a mechanism to secure a piece of equipment, such as a backpack blower, to the upper locking assembly and the lower support assembly.

### CROSS REFERENCE

In accordance with 37 C.F.R. 1.76, a claim of priority is included in an Application Data Sheet filed concurrently herewith. Accordingly, the present invention claims priority to U.S. Provisional Application No. 62/699,315, entitled, “SECURING RACK FOR BACKPACK BLOWER”, filed Jul. 17, 2018. The contents of the above referenced application are incorporated herein by reference in their entirety.

### FIELD OF THE INVENTION

The present invention relates to equipment racks; more particularly, to lockable equipment racks configured to secure a backpack blower thereto.

### BACKGROUND OF THE INVENTION

Lawn care service providers utilize multiple types of equipment to properly maintain a lawn or outdoor landscape. Some pieces of equipment, such as lawn mowers, are large and heavy enough that the risk of theft is low; other types of equipment, such as trimmers or backpack blowers, are small enough that theft of such items is a real concern. Given their size, easy portability, and cost, it is very beneficial for companies to somehow secure such items in order to prevent loss while at a job site. This is particularly important for companies that remain on a particular job site for extended periods of time and use multiple types of equipment.

One mechanism to keep easily portable items from theft would be to lock them up within a vehicle. While simple in nature, execution can be difficult, as lawn care vehicles are often left open to move equipment in and out quickly, use open air trailers in transporting landscaping equipment, or are unattended for extended periods of time. All this leads to difficulty in simply locking equipment within a vehicle. Alternatively, specialized locking equipment can be utilized to secure such items to a vehicle, regardless if using an open air trailer. For example, U.S. Pat. Nos. 7,762,408 and 8,245,859 describe specialized locking equipment racks for use with trimmers. Other equipment, like backpack blowers, require a specialized equipment rack to properly secure the devices. U.S. Pat. No. 9,045,918 illustrates an example of a locking equipment rack for use with backpack blowers. The design of the '918 patent was bulky, cumbersome, and could not be adapted to fit multiple backpack blower brands without the need of additional brackets or parts.

### SUMMARY OF THE INVENTION

The present invention relates to equipment racks; more particularly, to lockable equipment racks configured to secure a backpack blower thereto. The locking equipment rack comprises an upper locking assembly and a lower support assembly. The upper locking assembly and the lower support assembly are securable to and movable about a first post and a second post. Attached to the second post is a tube holder assembly configured to receive and hold at least a portion of an air discharge tube or pipe designed to move air. A locking unit provides a mechanism to secure a piece of equipment, such as a backpack blower, to the upper locking assembly and the lower support assembly.

In an illustrative example, the device for locking equipment configured to maintain equipment in a secured position when engaged therewith may comprise a first post; a second post, said second post separated from said first post via a distance and arranged in a generally parallel manner; an upper locking assembly; and a lower support assembly. The device for locking equipment configured to maintain equipment in a secured position when engaged therewith may further include a tube holder assembly configured to receive and hold at least a portion of an air discharge tube or pipe designed to move air.

Accordingly, it is an objective of the invention to provide an equipment rack configured to secure equipment.

It is a further objective of the invention to provide a lockable equipment rack configured to secure equipment.

It is yet another objective of the invention to provide a lockable equipment rack configured to secure a backpack blower.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a front perspective view of an illustrative embodiment of an equipment securing rack;

FIG. 2 is an alternative front perspective view of the equipment securing rack;

FIG. 3 is a back perspective view of the equipment securing rack;

FIG. 4 is a front view of the equipment securing rack;

FIG. 5 is a back view of the equipment securing rack;

FIG. 6 is a left side view of the equipment securing rack;

FIG. 7 is a right side view of the equipment securing rack;

FIG. 8 is a top view of the equipment securing rack;

FIG. 9 is a bottom view of the equipment securing rack;

FIG. 10 is an exploded view of the equipment securing rack;

FIG. 11 is a perspective view of the equipment locking bar;

FIG. 12 is a partial exploded view of the equipment locking bar;

FIG. 13 is a perspective view of the equipment securing rack, illustrating movement of the equipment locking bar;

FIG. 14 is a perspective view of the equipment securing rack, illustrating additional movement of the equipment locking bar;

FIG. 15 is a perspective view of the equipment securing rack, illustrating additional movement of the equipment locking bar;

FIG. 16 is an exploded view of an embodiment of the locking unit;

FIG. 17 is a front view of the locking unit;

FIG. 18 illustrates the internal components of the locking unit;

FIG. 19 illustrates a backpack blower secured to the equipment securing rack;

FIG. 20 illustrates the equipment securing rack secured to a wall of a closed truck;

FIG. 21 illustrates the equipment securing rack secured to a portion of an open bed truck;

FIG. 22 illustrates an alternative view of the equipment securing rack secured to a portion of an open bed truck; and

FIG. 23 illustrates stacked equipment securing racks.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

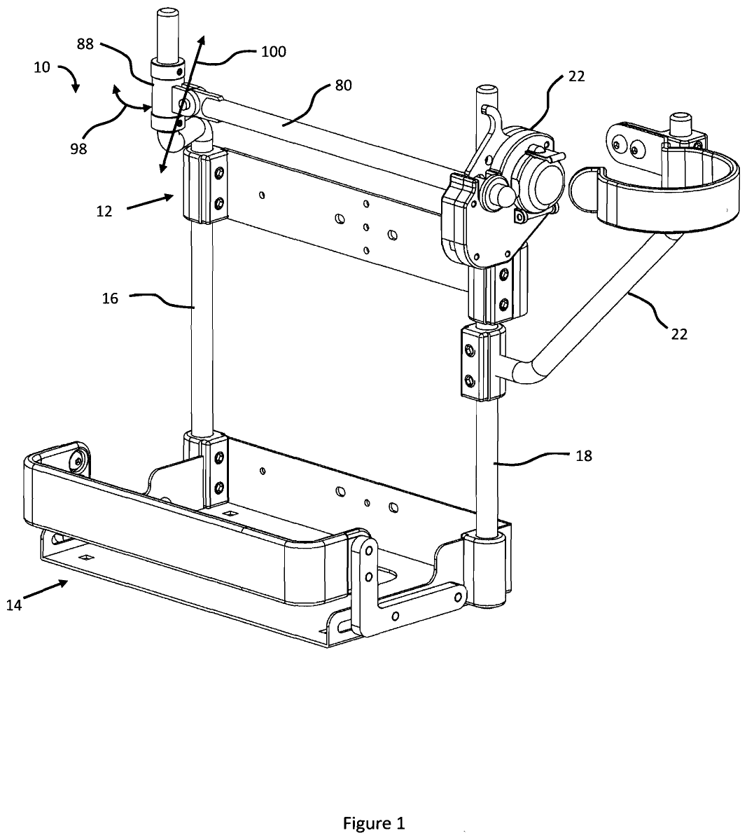

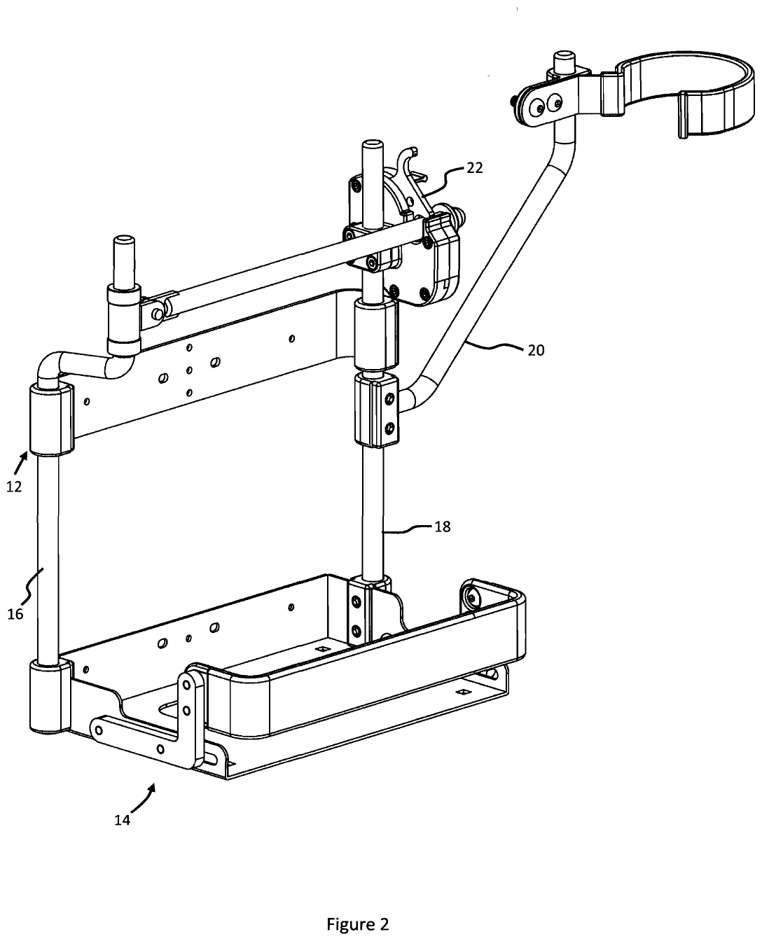

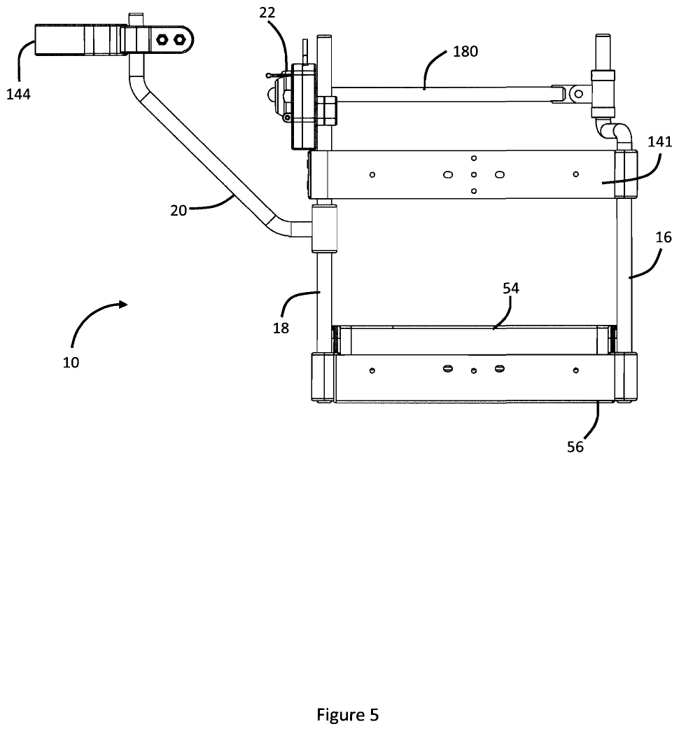

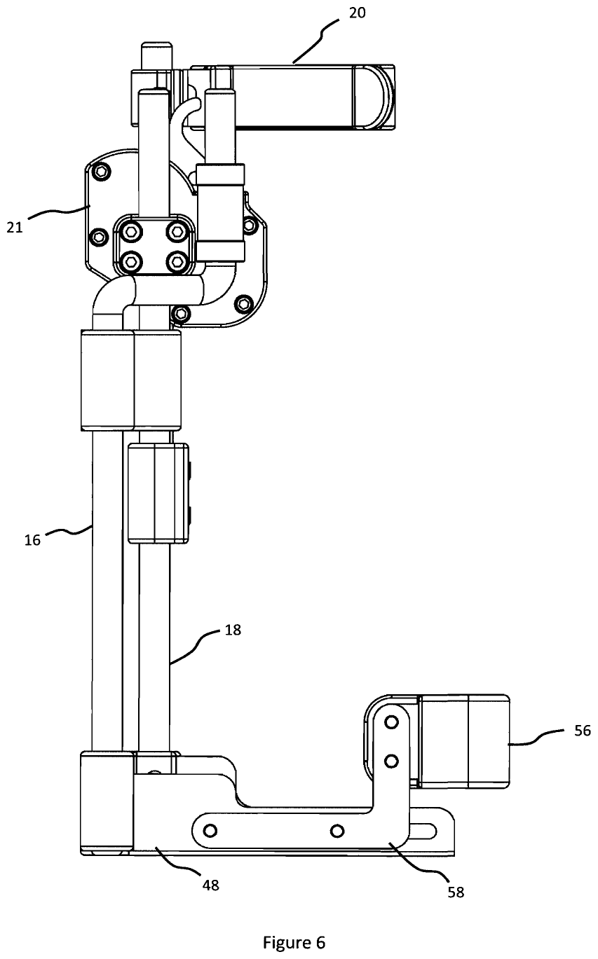

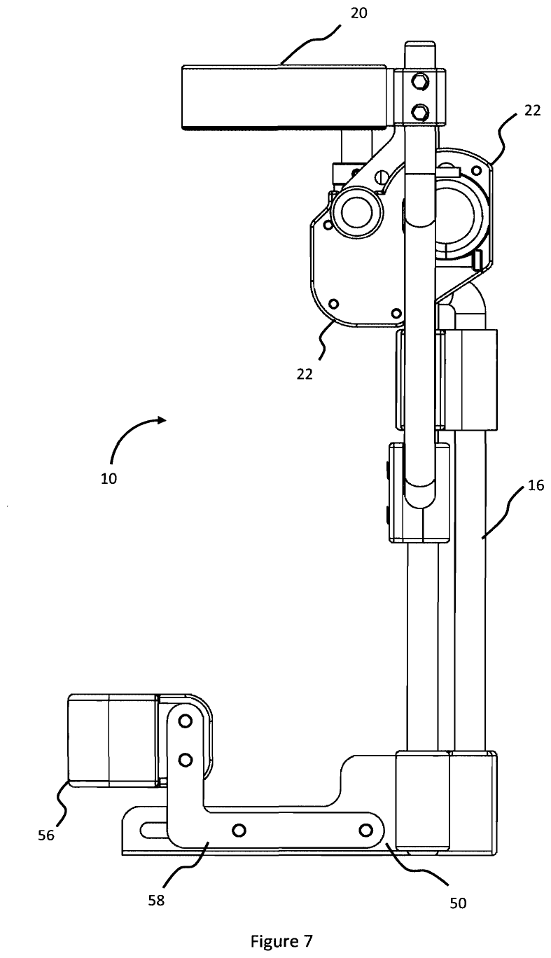

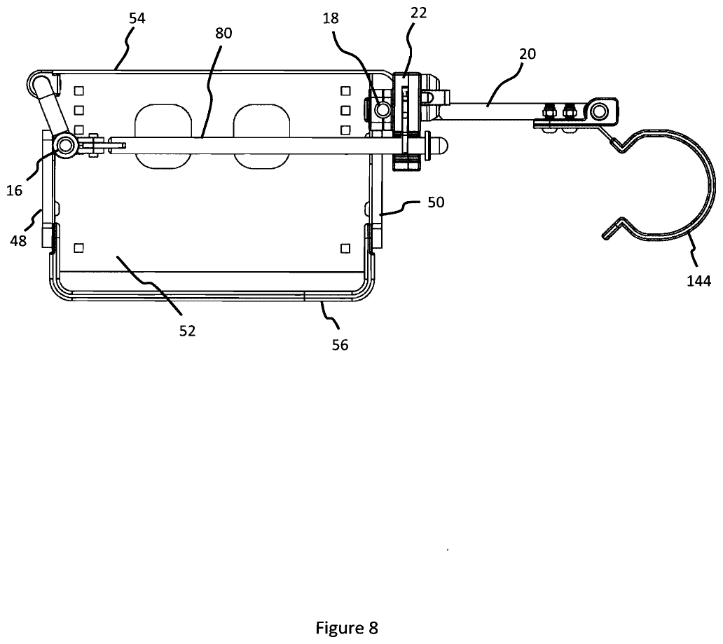

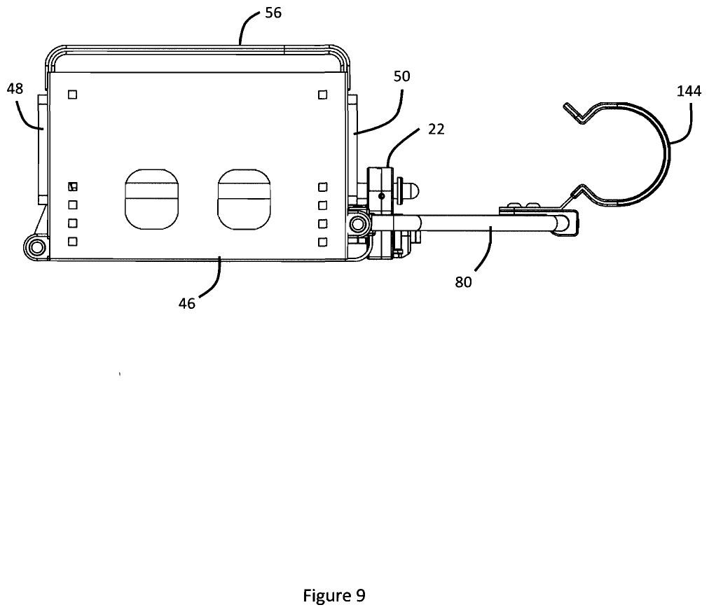

Referring to FIGS. 1-9, an embodiment of an equipment rack, referred to generally as a locking equipment rack 10, is illustrated. The locking equipment rack 10 comprises an upper locking assembly 12 and a lower support assembly 14. The upper locking assembly 12 and the lower support assembly 14 are securable to and movable about a first post 16 and a second post 18. Relative to each other, the first post 16 and the second post 18 are arranged in a generally parallel orientation. Attached to the second post 18 is a tube holder assembly 20 configured to receive and hold at least a portion of an air discharge tube or pipe designed to move air, such as a bellows hose or a blower air jet nozzle. A locking unit 22 provides a mechanism to secure a piece of equipment, such as a backpack blower, to the upper locking assembly 12 and to the lower support assembly 14.

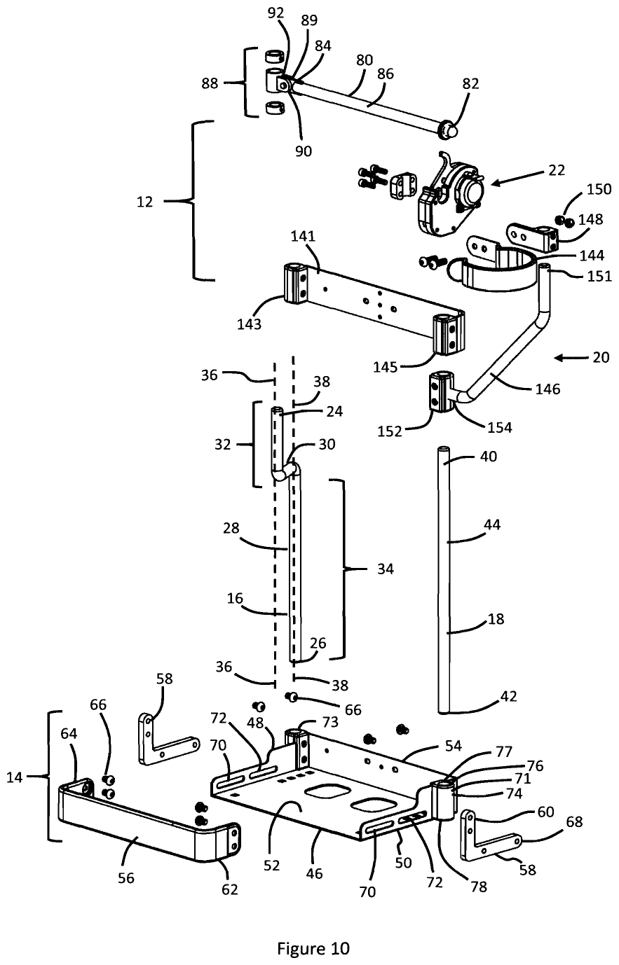

The first post 16 has a first end 24, a second opposing end 26, and a first post main body 28 therebetween, see FIG. 10. The first post main body 28 may contain a bend 30. The bend 30 divides the first post main body 28 into two sections: a short section 32 and a long section 34. The short section 32 is configured to have a shorter length than the long section 34. As a result of the bend 30, the short section 32 is oriented or positioned in a first plane 36 and the long section is oriented or positioned in a second plane 38, with the first plane 36 being a different plane than the second plane 38, and aligned in a generally parallel manner. Alternatively, lines 36 and 38 may represent a longitudinal axis of the short section 32 or the long section 34, respectively. The second post 18 has a first end 40, a second opposing end 42, and a second post main body 44 therebetween.

The lower support assembly 14 comprises a support structure 46 having two opposing side walls 48 and 50, separated by a bottom wall 52. A back wall 54 partially encloses the bottom wall 52. A front lower support assembly bracket 56 secures to the two opposing side walls 48 and 50 via L-shaped securing brackets 58. The L-shaped securing brackets 58 comprise a vertical elongated body 60 configured to secure to side section 62 or 64 of the front lower support assembly bracket 56 via securing members, illustrated herein as screws 66, and a horizontal elongated body 68 configured to secure to side wall 48 or side wall 50.

Each side wall 48 or 50 comprises a first slotted region or cut-out 70 and second slotted region or cut-out 72. The horizontal elongated body 68 may be secured to the first and second slotted regions, or cut-outs, 70 and 72, via screws. The placement or positioning of the front lower support assembly bracket 56, thus the securing of the backpack blower placed within the lower support assembly 14, can be modified by positioning the horizontal elongated body 68 anywhere within the slotted regions or cut-outs 70 and 72, and securing in place. A pair of lower post receiving members 73, 74 are located or positioned on the lower support assembly support structure side wall 48 and lower support assembly support structure side wall 50. The lower post receiving collar 71 has a main generally tubular shaped body 76 with an open top end 77. The open top end 77 provides access to the interior portion (not shown) lower post receiving collar 71, and an open or closed bottom end 78. While the tubular shaped body 76 need not be tubular in shape, it is sized and shaped to receive and hold at least a portion of the lower end 42 of the second post 18. The lower post receiving member 74 has the same features as that described for the lower post receiving member 73, and is configured to receive and hold the lower end 26 of the first post 16. In this configuration, the lower support assembly 14 can be moved, positioned, or secured to variable positions about the first post 16 and the second post 18.

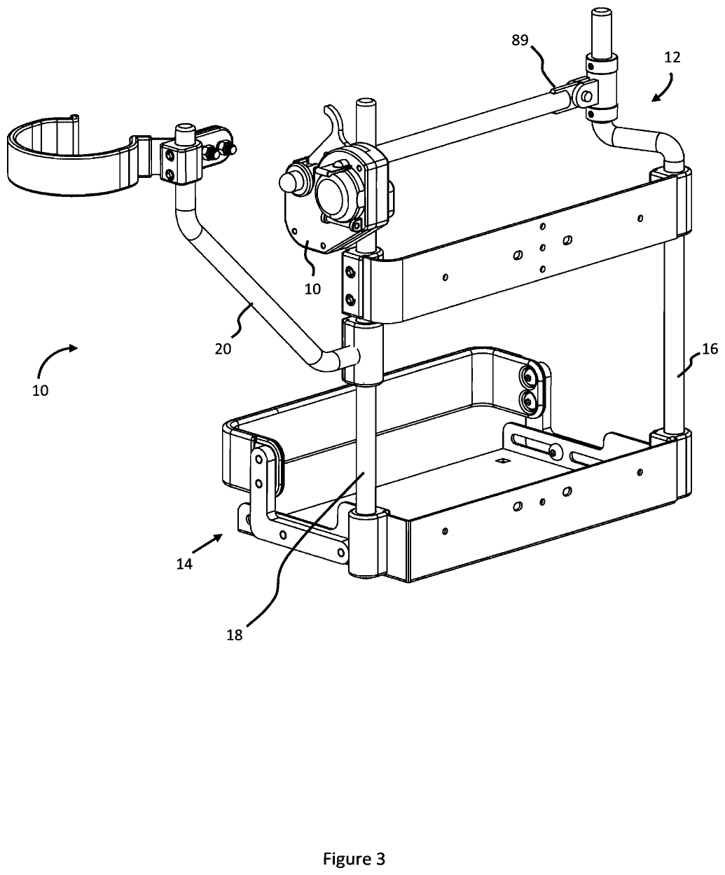

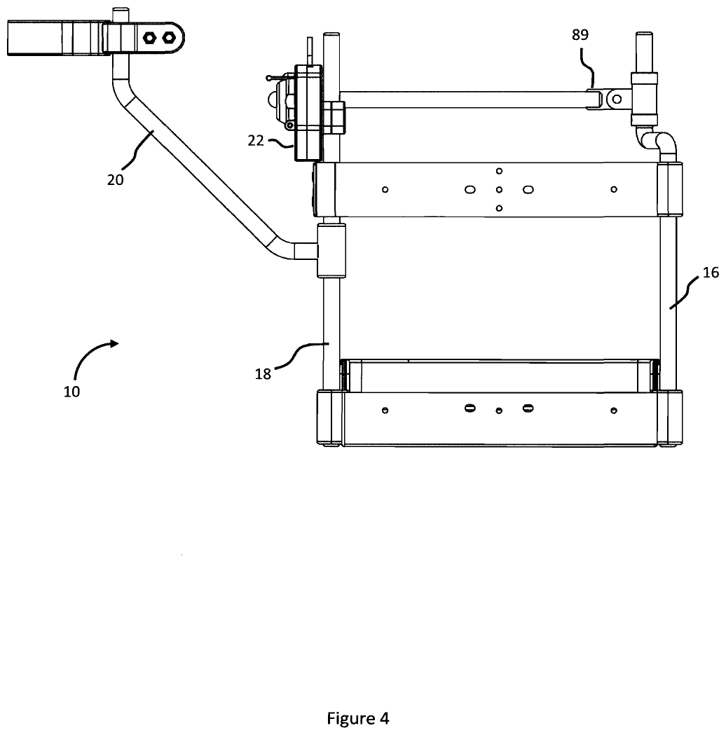

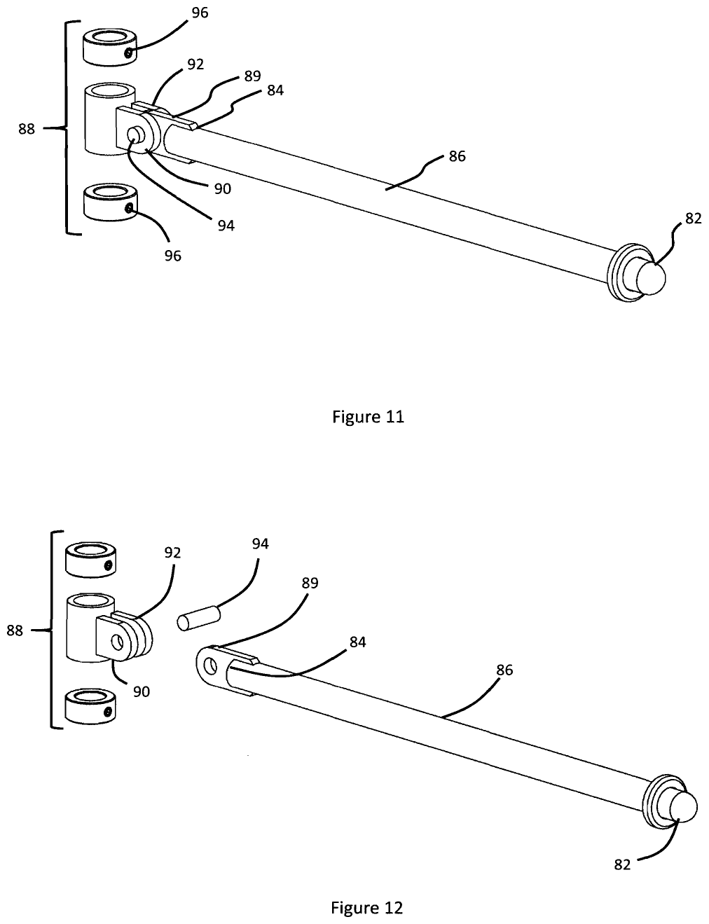

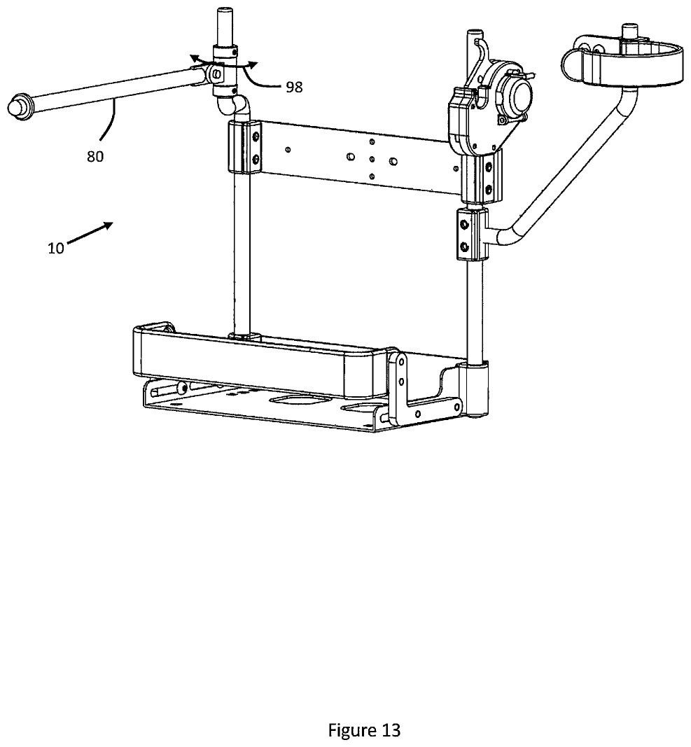

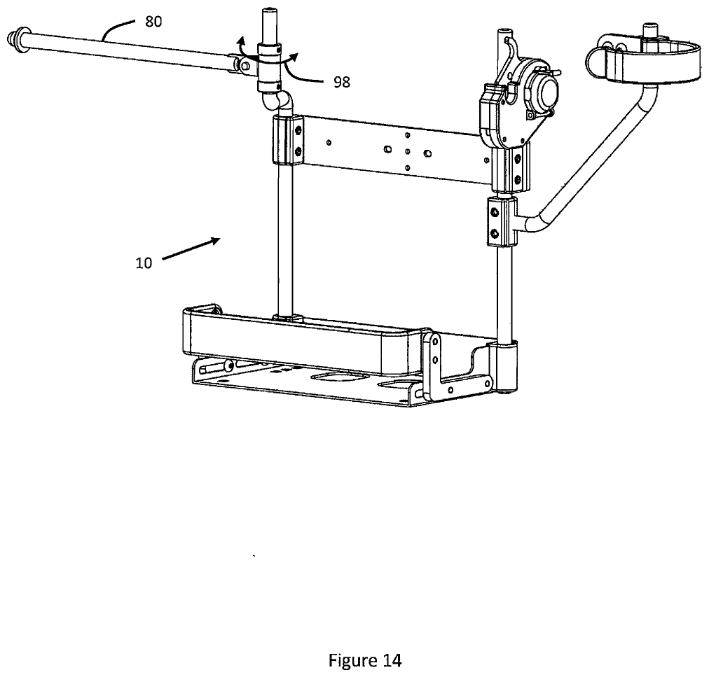

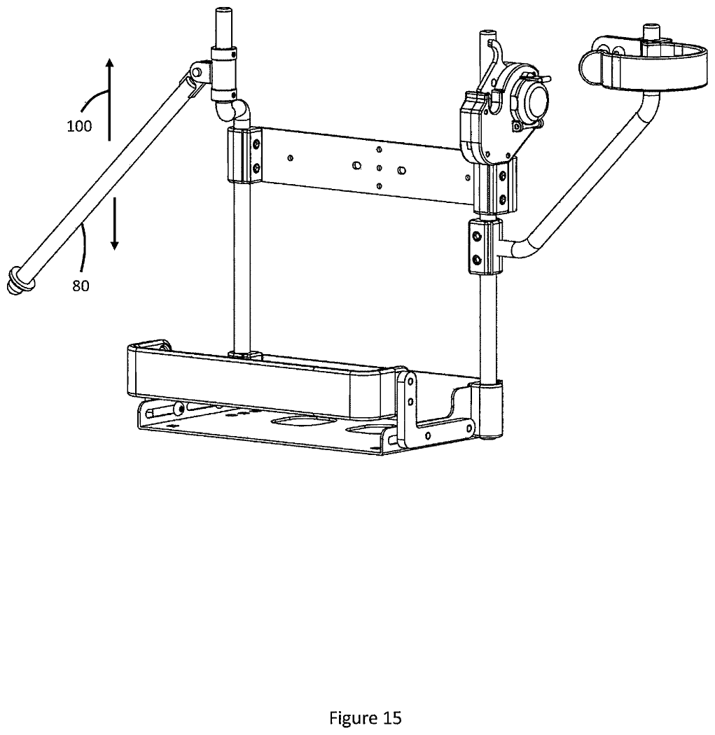

The upper locking assembly 12 comprises an equipment locking bar 80 having a first end 82, a second end 84, and a locking bar main body 86, illustrated as an elongated tubular post, therebetween, see FIGS. 10, 11 and 12. The first end 82 is configured to engage with a portion of the locking unit 22. The second end 84 engages with and secures to a set screw collar 88 via a U-shaped bracket 89 secured to welded tabs 90 and 92 with a pin 94, see also, FIG. 3 and FIG. 4. The set screw collar 88 secures to the short section 32 of first post 16 via screws 96, thus allowing the locking bar main body 86 to be moved, positioned, or secured to one or more locations about the first post 16. The locking bar main body 86 is designed to move within various degrees of movement. For example, the locking bar main body 86 may spin or move 360 degrees (either direction, clockwise or counter clockwise) about the set screw collar 88 or first post 16, see arrows 98, FIG. 1. The locking bar main body 86 may also move in the direction of arrows 100, (movable at least 90 degrees or greater in an upward direction or at least 90 degrees or greater in a downward direction relative to said first post first plane 36), see FIG. 1, thus moving above and below its locked position, i.e. the position in which it is locked to the locking unit 22. FIGS. 13 and 14 illustrate the directional movement of the upper locking assembly equipment locking bar 80 with regards to arrows 98. FIG. 15 illustrates the directional movement of the upper locking assembly equipment locking bar 80 with regards to arrows 100.

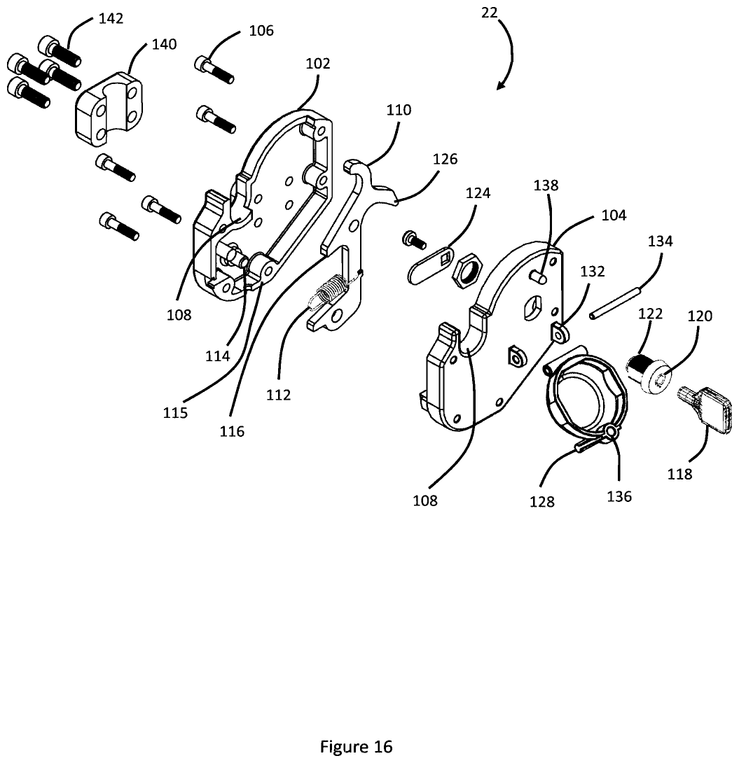

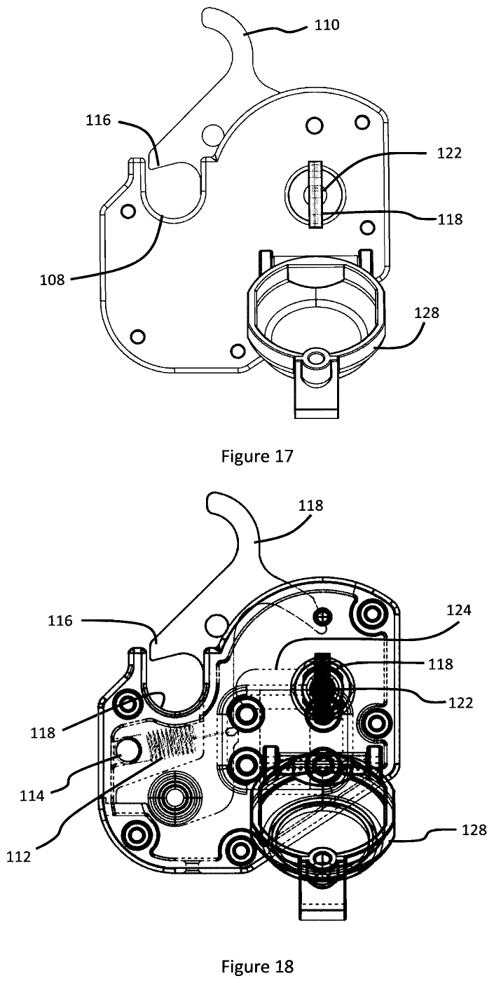

The first end 82 of the upper locking assembly equipment locking bar 80 engages with a portion of the locking unit 22 to lock the equipment rack 10. FIG. 16 provides an exploded view of the spring loaded locking unit 22. The spring loaded locking unit 22 comprises two outer units 102 and 104 secured together using screws 106, thus providing an enclosed unit which stores additional components. The first end 82 of the upper locking assembly equipment locking bar 80 is configured to engage and rest within the spring loaded locking unit U-shaped cut-out upper locking assembly equipment locking bar receiving region 108, see also FIG. 17. The locking unit U-shaped cut-out region 108 is sized and shaped to receive and hold at least a portion of the upper locking assembly equipment locking bar main body 86. A locking latch or clasp 110, with spring 112 attached to spring post 114, moves, so that when in a locked position, the locking latch overhang portion 116 covers the spring loaded locking unit U-shaped cut-out upper locking assembly equipment locking bar receiving region 108, locking the upper locking assembly equipment locking bar 80 in place. The locking latch 110 is rotatably attached to the bracket 115 via a pin (not shown). To lock or unlock the locking latch 110 in place, a user inserts a key 118 into a key way 120 of a lock 122. The locking plate 124 moves relative to the locking latch handle 126, thereby locking or unlocking the locking lever locking latch 110 in place. A lock cover 128 is rotatably secured to the outer unit 104 via brackets 130 and 132 and pin 134. An opening 136 on the lock cover 128 receives a peg 138 to lock the lock cover 128 to the outer unit 104. The locking unit secures to the second post 18 through a cap 140 and screws 142, thus providing a mechanism for height adjustment.

A back upper support assembly bracket 141 secures to the first end 24 of the first post 16 through a first back upper support assembly bracket collar 143, see FIG. 10. The back upper support assembly bracket 141 also secures to the first end of the second post 18 through a second back upper support assembly bracket collar 145.

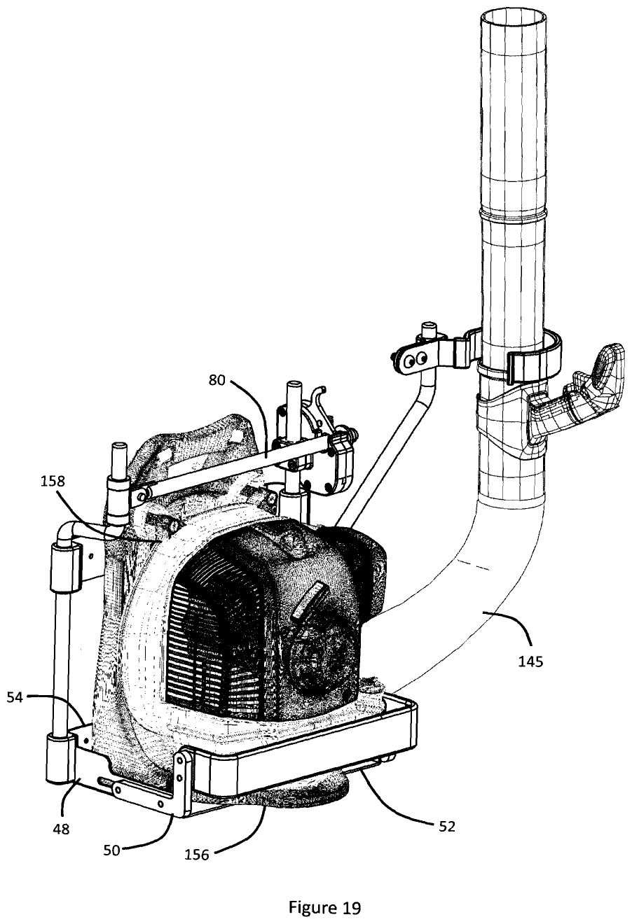

Referring to FIG. 10 or FIG. 19, the tube holder assembly 20 is configured to receive and hold at least a portion of an air discharge tube 145, such as a bellows hose or a blower air jet nozzle. The tube holder assembly 20 comprises an air discharge tube receiving member, illustrated herein as a U-shaped bracket 144. The U-shaped bracket 144 may be made of a flexible material that can be bent out of shape when a sufficient force is applied, but snap back to its original shape when the force is removed. The U-shaped bracket 144 secures to arm 146 via a first tube holder assembly collar 148 and screws 150 at the first end 151 of the arm 146. The U-shaped bracket 144 secures to the second post 18 via a second tube holder assembly collar 152 and screws 150 positioned at the second end 154 of the arm 146. Moving the second tube holder assembly collar 152 up or down the second post 18 provides a mechanism for height adjustment.

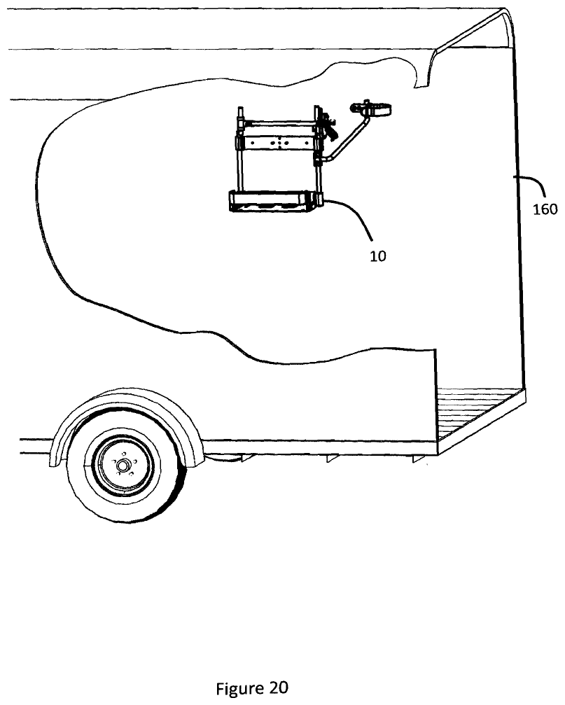

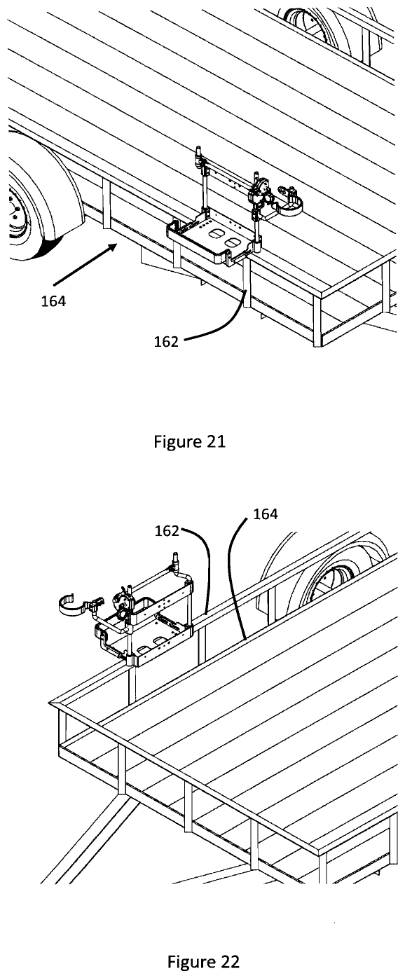

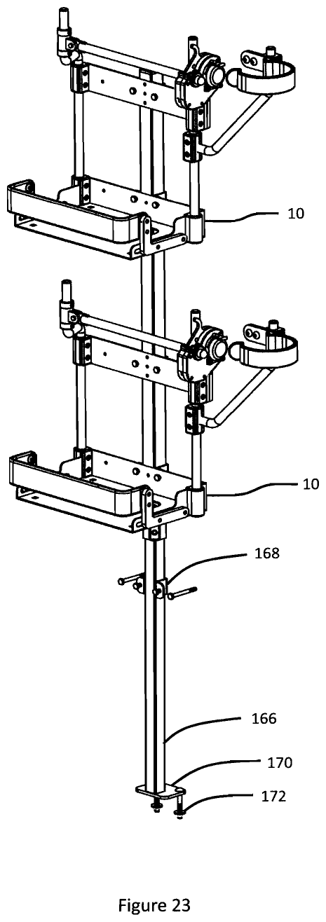

FIG. 19 illustrates a backpack blower 156 locked in the locking equipment rack 10. As illustrated, a portion of the backpack blower 156 fits and is locked within the lower support assembly 14. A portion of the backpack blower 156 rests on the support structure bottom wall 52, and within side walls 48, 50, of the bottom wall 52, and the front lower support assembly bracket 56. The upper locking assembly equipment locking bar 80 runs across an upper portion 158 of the backpack blower 156. The locking equipment rack 10 may be secured to or positioned within a closed trailer, box truck 160, FIG. 20, or on a flat wall. The locking equipment rack 10 may be secured to rails 162 or positioned within a cargo bed of an open air truck 164, see FIGS. 21 and 22. Referring to FIG. 23, multiple locking equipment racks 10 may be secured to a central post in order to provide stacked units, thus securing multiple pieces of equipment in a limited space along a post 166. The post 166 may be secured to a cargo bed of an open air truck or to the walls of a closed truck through brackets 168 and 170 and screws 172.

All patents and publications mentioned in this specification are indicative of the levels of those skilled in the art to which the invention pertains.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A device for locking equipment configured to maintain equipment in a secured position when engaged therewith comprising:
a first post;
a second post, said second post separated from said first post via a distance, and arranged in a generally parallel manner
an upper locking assembly; and
a lower support assembly.

2. The device for locking equipment configured to maintain equipment in a secured position when engaged therewith according to claim 1, further including a tube holder assembly configured to receive and hold at least a portion of an air discharge tube or pipe designed to move air.

3. The device for locking equipment configured to maintain equipment in a secured position when engaged therewith according to claim 1, wherein said first post has a first end, a second opposing end, and a first post main body, said first post main body containing a bend.

4. The device for locking equipment configured to maintain equipment in a secured position when engaged therewith according to claim 3, wherein said bend divides said first post main body into a short section and a long section.

5. The device for locking equipment configured to maintain equipment in a secured position when engaged therewith according to claim 4, wherein said short section is configured to have a shorter length than said long section.

6. The device for locking equipment configured to maintain equipment in a secured position when engaged therewith according to claim 1, wherein said upper locking assembly comprises:
an equipment locking bar having a first end, a second end, and a locking bar main body, and
a locking unit.

7. The device for locking equipment configured to maintain equipment in a secured position when engaged therewith according to claim 6, wherein said equipment locking bar secures to said first post in a manner which allows for movement in multiple directions.

8. The device for locking equipment configured to maintain equipment in a secured position when engaged therewith according to claim 7, wherein said equipment locking bar is movable at least 90 degrees in an upward direction or at least 90 degrees in a downward direction relative to said first post first plane.

9. The device for locking equipment configured to maintain equipment in a secured position when engaged therewith according to claim 7, wherein said equipment locking bar rotates 360 degrees about said first post.

10. The device for locking equipment configured to maintain equipment in a secured position when engaged therewith according to claim 7, wherein said equipment locking bar is movable at least 90 degrees in an upward direction or at least 90 degrees in a downward direction relative to said first post first plane, and rotates 360 degrees about said first post.

11. The device for locking equipment configured to maintain equipment in a secured position when engaged therewith according to claim 6, wherein said locking unit is spring loaded.

12. The device for locking equipment configured to maintain equipment in a secured position when engaged therewith according to claim 1, wherein said upper locking assembly includes an upper support assembly bracket having a first end secured to said first post and a second end secured to said second post.

13. The device for locking equipment configured to maintain equipment in a secured position when engaged therewith according to claim 12, wherein said upper locking assembly includes a cut-out region sized and shaped to receive and hold at least a portion of said upper locking assembly equipment locking bar main body.

14. The device for locking equipment configured to maintain equipment in a secured position when engaged therewith according to claim 2, wherein said tube holder assembly comprises:
an air discharge tube receiving member configured to receive and hold at least a portion of an air discharge tube, and
an elongated member secured to said second post.

15. The device for locking equipment configured to maintain equipment in a secured position when engaged therewith according to claim 14, wherein said air discharge tube receiving member is a U-shaped bracket made of a flexible material that can be bent out of shape when a sufficient force is applied, and return to its original shape when said force is removed.

16. The device for locking equipment configured to maintain equipment in a secured position when engaged therewith according to claim 1, wherein said lower support assembly comprises a support structure having two opposing side walls, a bottom wall separating said two opposing side walls, and a back wall, which secured together partially encloses said bottom wall.

17. The device for locking equipment configured to maintain equipment in a secured position when engaged therewith according to claim 16, wherein said lower support assembly further comprises a front lower support assembly bracket secured to said two opposing side walls.
